(19) United States
(12) Patent Application Publication
(10) Pub. No.: US 2026/0291775 A1
(43) Pub. Date: Sep. 24, 2026

(54) METHODS OF INDIVIDUALIZING DEVICE IDENTIFICATIONS ON A NON-ARBITRATED BUS

(71) Applicant: HiViz Lighting, Inc., Hendersonville, NC (US)

(72) Inventors: Samuel T. Massa, Hendersonville, NC (US); Jesse Whitaker McRae, Hendersonville, NC (US)

(73) Assignee: HiViz Lighting, Inc., Hendersonville, NC (US)

(21) Appl. No.: 19/571,046

(22) Filed: Mar. 18, 2026

Related U.S. Application Data
(60) Provisional application No. 63/774,274, filed on Mar. 19, 2025.

(51) Int. Cl. H04L 12/413; H04L 12/40

(52) U.S. Cl. CPC H04L 12/413; H04L 2012/40273

(57) ABSTRACT

A method of individualizing device identifications on a non-arbitrated bus, the method including communicatively coupling each device of the plurality of devices to the non-arbitrated bus, scrambling all device identifications to random device identifications based on a random seed of each device of the plurality of devices, when one or more conflicts in the random device identifications is detected, re-scrambling each device of a subset of the plurality of devices, where the subset of the plurality of devices comprises each device having the one or more conflicts, and assigning each device of the plurality of devices a unique device identification.

### CROSS REFERENCE TO RELATED APPLICATION

This application claims the benefit of U.S. Provisional Application No. 63/774274 filed Mar. 19, 2025, the entire disclosure of which is hereby incorporated herein.

### BACKGROUND

Many data network devices (i.e., controller area network (CAN), local area network (LIN)) are pre-provisioned somehow so that they can go from “out of the box” state to “plays nicely on this specific network” state. Typically, this is done with hardware switches/rotaries or some software tool before they get installed on the network, however this creates an unnecessary burden to installers.

Further, the LIN protocol uses a master/child architecture where the master device polls child devices for messages, rather than allowing them to transmit at will. Because of this, each LIN child device (that is capable of transmitting) must be configured uniquely so that two devices don't respond at once to the same message poll from the master device, otherwise bus collision occurs, and the message is garbled. While there are messaging protocols that implement bus arbitration or collision detection as features of the protocol, none of these methods appear to have been formally implemented on the LIN bus. Accordingly, errors due to LIN collision still go undetected and thus unresolved.

Additionally, many devices on a data network must be custom provisioned to “play nicely” on the network in which they are installed. This may include a unique ID, location data, or other configuration data or metadata. In the event a device needs to be replaced or swapped for a similar device, this configuration may be lost in the process, creating an unnecessary burden of reconfiguration of the new device. Most networked systems currently require new nodes to be reconfigured by a technician to work like the node they are replacing, and many networked devices work off a single central controller, disallowing a decentralized means of monitoring and caching network states by anyone other than the single controller (now a single point of failure).

Accordingly, methods of individualizing device identifications on a non-arbitrated bus, such as for initially configuring a data network, remedying collisions in data networks, and replacing or moving devices in data networks are needed.

### SUMMARY

In one aspect, disclosed herein is a method of individualizing device identifications on a non-arbitrated bus, the method including communicatively coupling each device of a plurality of devices to the non-arbitrated bus, scrambling all device identifications to random device identifications based on a random seed of each device of the plurality of devices, when one or more conflicts in the random device identifications is detected, re-scrambling each device of a subset of the plurality of devices, wherein the subset of the plurality of devices comprises each device having the one or more conflicts, and assigning each device of the plurality of devices a unique device identification.

In some embodiments, the method further includes, after each device of the plurality of devices has a unique device ID, sending provisioning data to each device of the plurality of devices simultaneously, and re-mapping each device in the plurality of devices to a predetermined provisioned state based on the provisioning data.

In some embodiments, each device of the plurality of devices is selected from a light module, a processor, a global positioning system (GPS), a switch, or a user interface.

In some embodiments, the non-arbitrated bus communicatively couples each device to an emergency vehicle warning light system. In some embodiments, the emergency vehicle warning light system is coupled to a firetruck, ambulance, car, truck, boat, or helicopter.

In some embodiments, the provisioning data includes a predetermined identification. In some embodiments, the provisioning data includes provisioning metadata. In some embodiments, the provisioning metadata includes a provisioned location. In some embodiments, the provisioning metadata includes a presence of one or more child devices.

In some embodiments, the method further includes, when the one or more child devices are detected by a superset device of the plurality of devices, scrambling child identifications of the one or more child devices, simultaneously sending child provisioning data to each child device of the one or more child devices simultaneously, and re-mapping each child device of the one or more child devices to a predetermined provisioned state based on the provisioning data.

In some embodiments, the method further includes polling the plurality of devices with a master device, determining a failure in two or more responses provided by the plurality of devices, when the two or more responses each comprise a complete packet and a checksum failure, categorizing the failure as a duplicate sender failure, and scrambling each device of the plurality of devices determined to have caused the failure in the two or more responses so that each device of the plurality of devices has a unique identifier.

In some embodiments, the method further includes queuing a retransmission message a predetermined number of times to confirm the duplicate sender failure.

In some embodiments, the method further includes detecting a time drift in the failure, and, in response to the time drift, queuing a retransmission message.

In some embodiments, the method further includes caching provisioning data of the plurality of devices. In some embodiments, the provisioning data of the plurality of devices is cached by one or more devices of the plurality of devices. In some embodiments, the provisioning data of the plurality of devices is cached on an external network communicatively coupled to the non-arbitrated bus with a routing algorithm. In some embodiments, the provisioning data of the plurality of devices is stored in a persistent memory.

In some embodiments, the method further includes determining that a device of the plurality of devices has moved to a new location, and re-provisioning the device at the new location.

In some embodiments, the method further includes detecting an absent device of the plurality of devices, detecting a replacement device having a same type as the absent device, and provisioning the replacement device with provisioning data of the absent device. In some embodiments, the method further includes issuing an alert that the replacement device has been detected.

In another aspect, disclosed herein is a method of individualizing device identifications on a non-arbitrated bus, the method including polling a plurality of devices with a master device, determining a failure in two or more responses provided by the plurality of devices, when the two or more responses each comprise a complete packet and a checksum failure, categorizing the failure as a duplicate sender failure, and scrambling each device of the plurality of devices determined to have caused the failure in the two or more responses so that each device of the plurality of devices has a unique identifier.

In some embodiments, the method further includes queuing a retransmission message a predetermined number of times to confirm the duplicate sender failure.

In some embodiments, the method further includes detecting a time drift in the failure, and in response to the time drift, queuing a retransmission message. In some embodiments, the method further includes detecting multiple responses to a query, queuing a retransmission message.

In some embodiments, each device of the plurality of devices is selected from a light module, a processor, a global positioning system (GPS), a switch, or a user interface.

In some embodiments, the non-arbitrated bus communicatively couples each device to an emergency vehicle warning light system. In some embodiments, the emergency vehicle warning light system is coupled to a firetruck, ambulance, car, truck, boat, or helicopter.

In yet another aspect, disclosed herein is a method of reconfiguring a system having a plurality of devices communicatively coupled to a non-arbitrated bus including detecting an absent device of the plurality of devices, detecting a replacement device having a same type as the absent device, and provisioning the replacement device with provisioning data of the absent device.

In some embodiments, the method further includes issuing an alert that the replacement device has been detected.

In some embodiments, the provisioning data of the plurality of devices is cached by one or more devices of the plurality of devices. In some embodiments, the provisioning data of the plurality of devices is cached on an external network communicatively coupled to the non-arbitrated bus with a routing algorithm. In some embodiments, the provisioning data of the plurality of devices is stored in a persistent memory.

In yet another aspect, disclosed herein is a method of reconfiguring a system having a plurality of devices communicatively coupled to a non-arbitrated bus, the method including determining that a device of the plurality of devices has moved to a new location; and re-provisioning the device at the new location.

In some embodiments, each device of the plurality of devices is selected from a light module, a processor, a global positioning system (GPS), a switch, or a user interface.

In some embodiments, the non-arbitrated bus communicatively couples each device to an emergency vehicle warning light system. In some embodiments, the emergency vehicle warning light system is coupled to a firetruck, ambulance, car, truck, boat, or helicopter.

In another aspect, disclosed herein is a method of reconfiguring a system having a plurality of devices communicatively coupled to a non-arbitrated bus, the method including detecting an absent device of the plurality of devices, detecting a replacement device having a same type as the absent device, and provisioning the replacement device with provisioning data of the absent device.

In some embodiments, the method further includes issuing an alert that the replacement device has been detected.

In some embodiments, the provisioning data of the plurality of devices is cached by one or more devices of the plurality of devices.

In some embodiments, the provisioning data of the plurality of devices is cached on an external network communicatively coupled to the non-arbitrated bus with a routing algorithm.

In some embodiments, the provisioning data of the plurality of devices is stored in a persistent memory.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an example emergency lighting system, in accordance with the present technology;

FIG. 2 is a block diagram of an example system, in accordance with the present technology;

FIG. 3 is an example method of individualizing device identifications on a non-arbitrated bus, in accordance with the present technology;

FIG. 4 is another example method of individualizing device identifications on a non-arbitrated bus, in accordance with the present technology;

FIG. 5 is another example method of individualizing device identifications on a non-arbitrated bus, in accordance with the present technology;

FIG. 6 is yet another example method of individualizing device identifications on a non-arbitrated bus, in accordance with the present technology; and

FIG. 7 is an example method of reconfiguring a system having a plurality of devices communicatively coupled to a non-arbitrated bus.

### DETAILED DESCRIPTION

Disclosed herein are methods of individualizing device identifications on a non-arbitrated bus, such as for initially configuring a data network, remedying collisions in data networks, and replacing or moving devices in data networks.

In one aspect, disclosed herein is a method of inline provisioning that allows all devices to be fully installed, powered, and wired in their initial “out of the box” state, and then device provisioning to happen with all the devices together. This saves installers time and burden and reduces the need for mistake causing devices to be removed after installation to correct a mistake.

In some embodiments, devices are all the same “un-provisioned” out of the box state, but with random number seeds configured at manufacturing time. Initially, all “un-provisioned” devices are told to scramble to random IDs, and then any devices with ID conflicts only are re-scrambled iteratively until all devices on the network have unique IDs (making them uniquely addressable). With each device now unique (but random), each is identified on the network visually via an identify process, and after identifying each device all the correct (non-random) provisioning data, including both correct ID and other provisioning metadata, is sent in a burst all at once for all devices. After the full burst is received by all devices (and not before, since all need to happen simultaneously for this process), each device executes the “remapping” data from its random “un-provisioned” out of the box state to the correct provisioned state.

To make the above simpler across a system consisting of a primary network with multiple subnetworks, each of which requires their own provisioning process, a two-tiered approach is supported for the primary network then all subnetworks, which is designed to allow unified code to support all possible network cases of all possible subnetworks. First, devices on the primary network are scrambled (if needed), identified, and provisioned per the previously described process. After this, devices detecting they have child devices may claim special “router” IDs, based on their provisioned location (part of the provisioning metadata). Secondary subnetwork devices may then be scrambled, identified, and provisioned through known “router” IDs, without needing to account for variance across system wiring configurations. This tiered approach allows a tree of any number of subnetworks to follow the same approach as the initial network.

In some embodiments, the method takes place on a primary CAN network with LIN subnetwork(s), and each subnetwork takes place one at a time. However, the process could translate into any other data network allowing two-way communication.

In another aspect, disclosed herein is a method of detecting LIN collision. LIN drivers may allow communication with the LIN application layer about specific details of a transmission failure, including how it failed and at what point of the LIN transmission handshake, rather than just marking it as failed and silently moving on. This allows more intelligent information (such as duplicate senders causing a bus collision) to be extracted from the failure data.

In some embodiments, the LIN collision detection allows a LIN master device to differentiate between “corrupt” or “incomplete” packets and “collided” packets. To do this, any packet that is received as complete (at least minimum number of bytes in expected response period) but with a checksum failure is marked by the driver layer to the application layer as “possibly duplicate senders”, alongside other information about the state of the driver and details of the failure. The application layer may then queue a retransmission message a number of times (“X” number of times), to determine if the same “possibly duplicate senders” callback is hit each time. In the event that the number of retransmits (“X” number of retransmits) happen normally then the event is marked as random corruption, however if identical “unique” failure states occur on each subsequent retransmission then more helpful conclusions may be reached.

The LIN driver layer may remain isolated from the application layer for this handshake, and no knowledge of the message itself is required by the application layer (other than expected length of packet), allowing for easy reuse and portability of the LIN driver supporting this software feature. The application layer should support this callback by the driver layer, but if unpopulated and unsupported by the LIN application there is no negative impact on the LIN driver itself. The advantages of this method for LIN collision detection are allowing auto-provisioning of “out of the box” LIN devices in a complex and feature rich LIN network, especially once consisting of near the max LIN node count of 16. More advantages include auto detection of misconfigured networks, as well as automated resolution of these misconfigured networks.

The method of detecting LIN collision may utilize algorithms having a number of configuration variables, such as the X variable listed previously that would denote the number of times to “retry” a believed collided message before concluding that there are in fact multiple LIN devices attempting to transmit at the same time.

Other modifications may include further detection of “time drift” in responses that don't create a direct failure but may lead to “random noise” on the bus, that is a second transmission response by a “too slow to respond” device that would have collided had it responded sooner.

Further modifications may include porting this method to other bus protocols, such as RS-485 or others, that are full duplex messaging protocols but without bus arbitration or collision detection built into the protocol.

In yet another aspect, disclosed herein is a method of swapping a single device that allows devices to be monitored and cached by each other, in a decentralized manner with multiple nodes all caching the state of all other devices on the network, and storing this data in persistent memory that survives power cycles. In the event a device is seen missing, but another device of the same type is seen on the same network (or subnetwork), a prompt may be given to alert a user that a single device swap is detected and may “auto provision” this new device in identical fashion to the removed device. This method allows other devices on a network to detect a 1:1 swap of “like types” of devices and auto provision the new device in an identical way to the old device, using previously cached data received from the old device, without manual user intervention. This approach allows every device to be a “single central controller” if it wishes to be, so that there is no single point of failure that cannot be “auto reprovisioned” by other devices on the network.

Variations may involve devices sharing provision data, and then being cached by other devices on the same network (or across separate networks through routing algorithms). Other variations or modifications may include polling devices rather than auto sharing or expanding “like types” device matching such that multiple devices could be swapped at once so long as “like types” were unique between them. Variations may also include allowing location data to change but matching a unique attribute of a device, allowing “auto move” of an existing device rather than just “auto reprovision” of a new device to replace an old one.

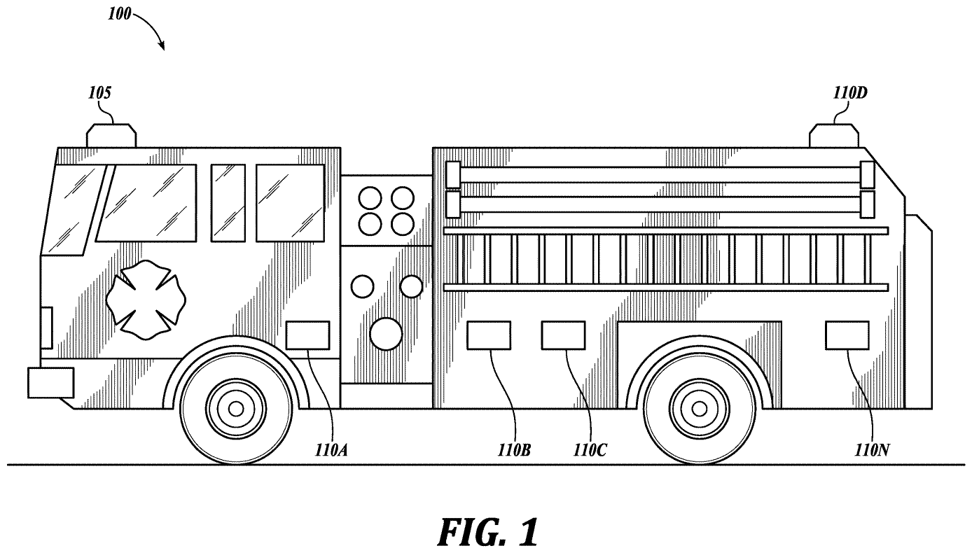

FIG. 1 is an example emergency lighting system 100, in accordance with the present technology.

In some embodiments, the emergency lighting system 100 may be incorporated into or onto a vehicle, such as a firetruck, as illustrated in FIG. 1. One skilled in the art should recognize that the emergency lighting system 100 may be incorporated onto any emergency vehicle or emergency system (such as a sign for directing traffic, etc.) including, but not limited to, an ambulance, a car, a truck, a semi, a boat, or a helicopter. In some embodiments the emergency lighting system 100 includes a plurality of light modules 110A, 110B, 110C, 110D . . . 110N. The plurality of light modules 110A, 110B, 110C, 110D . . . 110N may be included in a plurality of devices, which as used herein may include one or more light modules, one or more processors, one or more global positioning systems (GPS), one or more switches, one or more user interfaces, or a combination thereof.

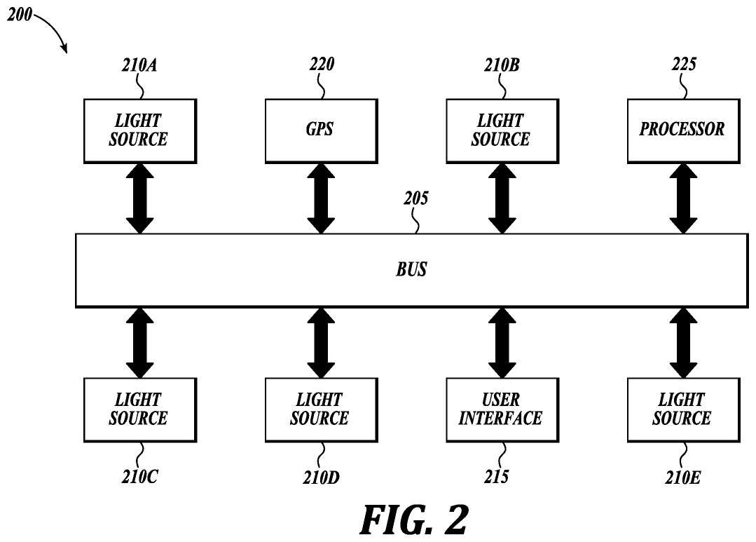

In some embodiments, the plurality of light modules 110A, 110B, 110C, 110D . . . 110N may be located remote from one another, but are all communicatively coupled to a non-arbitrated bus (as shown and described in FIG. 2). In this manner, each of the plurality of light modules 110A, 110B, 110C, 110D . . . 110N may be capable of communicating amongst each other to carry out one or more of the methods described herein.

In some embodiments, the emergency lighting system 100 further includes a light bar 105. In some embodiments, the light bar 105 is also considered a device of the plurality of devices. In some embodiments, such as when the light bar 105 is made up of two or more light modules, each light module of the light bar 105 is considered a device of the plurality of devices.

FIG. 2 is a block diagram of an example system, in accordance with the present technology.

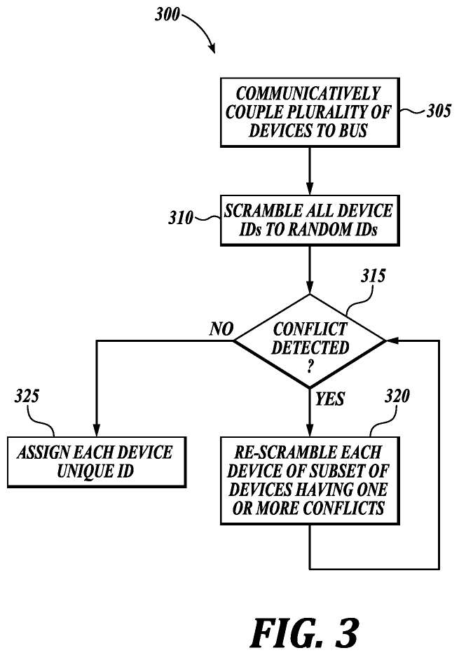

FIG. 3 is an example lighting system 100, in accordance with the present technology. In some embodiments, the lighting system 100 is a distributed network of smart light sources (collectively, “one or more light modules”) 210A, 210B, 210C, 210D, 210E. While five light sources are shown, it should be understood that the lighting system 100 includes any number of light sources, including a single light source. As used herein, the term “light source” and “light module” is synonymous.

In some embodiments, the system 100 further includes a processor 125, a user interface 120, a global positioning sensor (GPS) 115, and/or a switch 130. Each of these components may communicate with the one or more light modules 210A, 210B, 210C, 210D, 210E with a shared bus 205. Each light source of the one or more light modules 210A, 210B, 210C, 210D, 210E may comprise a separate microprocessor, configured to transmit data to the bus 200 (and eventually the processor 125), and receive commands.

In some embodiments, the system includes a user interface 120. In some embodiments, the user interface 120 is configured to accept one or more user commands as inputs. In some embodiments, the user interface 120 is a touchscreen. The user interface 120 may be located on a dashboard of an emergency vehicle, on a personal mobile device, on a computer, or the like.

In some embodiments, the lighting system 100 uses a distributed network of one or more light modules. In some embodiments, the one or more light modules are “smart,” that is, each includes a microcontroller that allows each light source to “know” what color light the light source is emitting, what the light source's intensity is, the location (and/or zone or sub-zone) of the light source, the photometry associated with the output of the light source, and/or an identifier of the light source.

In some embodiments, the one or more light sources 210A, 210B, 210C, 210D, 210E, can determine and transmit location data. In some embodiments, location data includes a zone and/or a sub-zone of the emergency vehicle that each light source is located.

In some embodiments, a distributed network of light modules 210A, 210B, 210C, 210D, 210E, all report and share data amongst themselves so that the light modules 210A, 210B, 210C, 210D, 210E can analyze their own statuses (or “characteristics”) as the relates to other light sources in the system. In some embodiments, each light source in a same zone is in communication with one another. In some embodiments, each light source of the lighting system is in communication with one another.

FIG. 3 is an example method of individualizing device identifications on a non-arbitrated bus, in accordance with the present technology.

In some embodiments, the method 300 is carried out with an emergency lighting system (such as emergency lighting systems 100, 200). In some embodiments, the emergency lighting system includes a non-arbitrated bus (such as bus 205) and a plurality of devices (such as plurality of light modules 110A, 110B, 110C, 110D . . . 110F and/or one or more light sources 210A, 210B, 210C, 210D, 210E, GPS 220, processor 225, and/or user interface 215).

In block 305, the plurality of devices is communicatively coupled with the bus (such as shown in FIG. 2).

In block 310, all device identifications (IDs) of each device in the plurality of devices are scrambled to random IDs. In some embodiments, each device of the plurality of devices has a same “un-provisioned state” before being coupled to the bus. At the time of manufacturing, each device may be assigned a random number seed. In some embodiments, the device IDs of the plurality of devices are scrambled to random IDs based on the random number seed.

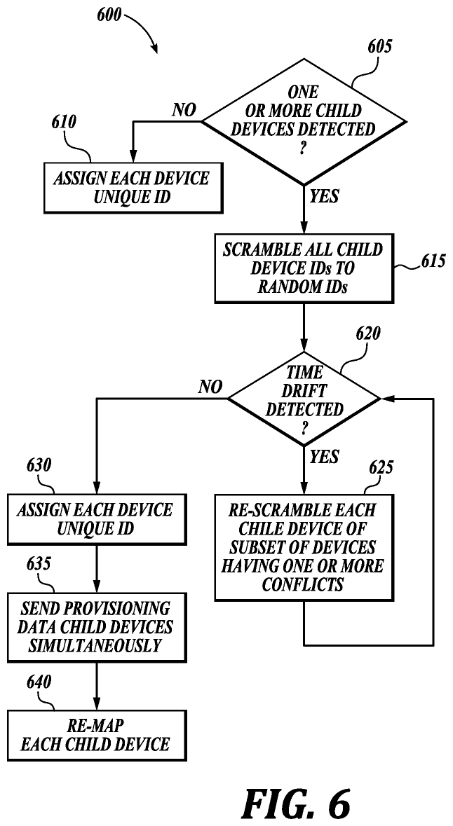

In decision block 315, it is determined whether there is a conflict between two or more random IDs of two or more devices of the plurality of devices. As used herein, a conflict exists when two or more random IDs are identical to one another. In some embodiments, the conflict may be detected when two or more responses from two or more devices each include a complete packet and a checksum failure, as described in detail in method 600 of FIG. 6. If a conflict is detected, the method proceeds to block 320.

In block 320, each random ID of each device of a subset of devices having one or more conflicts (i.e. each device of the two or more devices having responses with a complete packet and a checksum failure) are re-scrambled iteratively. The method then returns to decision block 315.

Returning to decision block 315, if conflicts are still detected, the method returns to block 320. In this manner, the random IDs may be iteratively re-scrambled until every device of the plurality of devices has a unique random ID. If no conflicts are detected, the method proceeds to block 325.

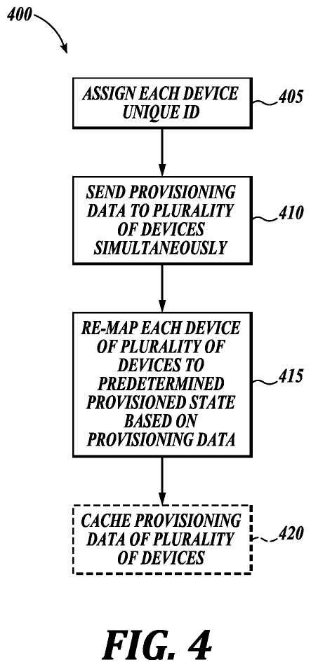

In block 325, each device is assigned a unique ID based on their random ID. In some embodiments, the method 300 may be followed with method 400 in FIG. 4.

FIG. 4 is another example method 400 of individualizing device identifications on a non-arbitrated bus, in accordance with the present technology.

In some embodiments, the method 400 may immediately follow method 300 of FIG. 3. In some embodiments, the method 400 is carried out with an emergency lighting system (such as emergency lighting systems 100, 200). In some embodiments, the emergency lighting system includes a non-arbitrated bus (such as bus 205) and a plurality of devices (such as plurality of light modules 110A, 110B, 110C, 110D . . . 110F and/or one or more light sources 210A, 210B, 210C, 210D, 210E, GPS 220, processor 225, and/or user interface 215).

In block 405, each device is assigned a unique ID. In some embodiments, this is achieved with the method 300.

In block 410, provisioning data is sent to the plurality of devices simultaneously. In some embodiments, the provisioning data is sent via the non-arbitrated bus. In some embodiments, the emergency lighting system includes a processor, which may send the provisioning data. In some embodiments, the provisioning data includes a predetermined identification and/or provisioning metadata. In some embodiments, the provisioning metadata includes a provisioned location and/or a presence of one or more child devices. In some embodiments, the one or more child devices may be a subset of the plurality of devices which report to a parent or master device within the emergency lighting system. In some embodiments, after identifying each device of the plurality of devices, all the predetermined or correct (i.e., non-random) provisioning data, including both provisioned ID and other provisioning metadata, is sent in a burst all at once for all devices of the plurality of devices. After the full burst is received by all devices (and not before, since all need to happen simultaneously for this process), the method proceeds to block 415.

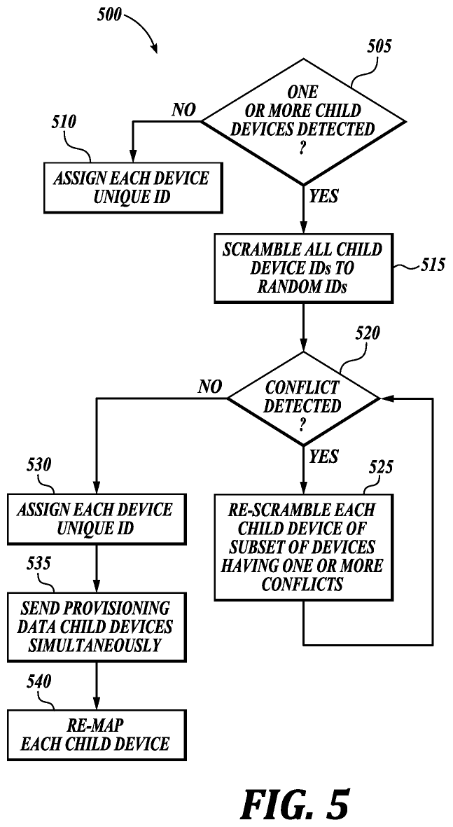

In block 415, each device of the plurality of devices is re-mapped to a predetermined provisioned state based on the provisioning data. In the case of child devices, the plurality of devices may be re-mapped according to the method 500 in FIG. 5.

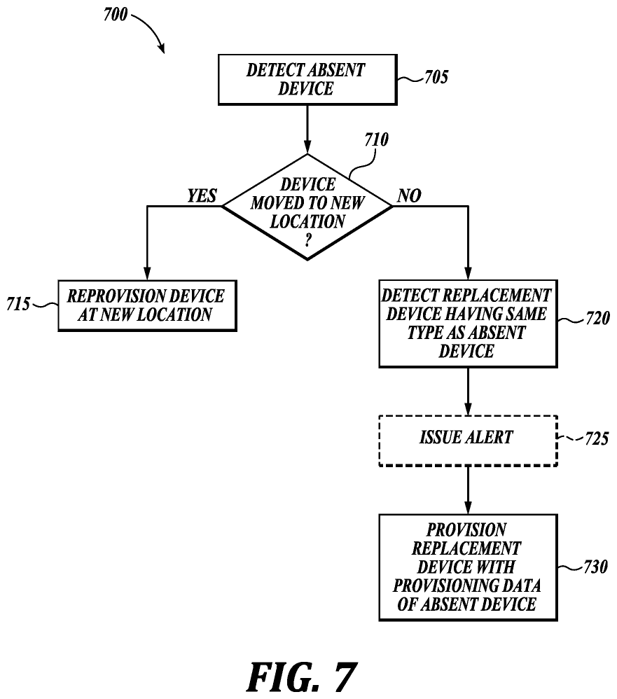

Optionally, in block 420, the provisioning state (or provisioning data) of each device of the plurality of devices is cached. This cached data may be used to determine when a device has been removed and/or replaced, as described in method 700 of FIG. 7.

FIG. 5 is another example method 500 of individualizing device identifications on a non-arbitrated bus, in accordance with the present technology.

In some embodiments, the method 500 may immediately follow method 400 of FIG. 4. In some embodiments, the method 500 is carried out with an emergency lighting system (such as emergency lighting systems 100, 200). In some embodiments, the emergency lighting system includes a non-arbitrated bus (such as bus 205) and a plurality of devices (such as plurality of light modules 110A, 110B, 110C, 110D . . . 110F and/or one or more light sources 210A, 210B, 210C, 210D, 210E, GPS 220, processor 225, and/or user interface 215).

In decision block 505, it is determined whether one or more child devices are detected. In some embodiments, this is determined with the provisioning metadata as described above. While only a single “sub-network” (i.e., a master device having one or more child devices) is shown as an example in method 500, it should be understood that any number of sub-networks may exist within the emergency lighting system. In some embodiments, each sub-network is provisioned independently and/or sequentially. In other embodiments, each sub-network is provisioned substantially simultaneously. In this manner, a 2-tiered approach is supported for the primary network then all subnetworks, which is designed to allow unified code to support all possible network cases of all possible subnetworks. In some embodiments, this process may be further implemented for sub-sub networks (i.e., subnetworks of the subnetworks) and so on. If no child devices are detected, the method proceeds to block 510.

In block 510, the device of the plurality of devices is assigned a unique device ID. In some embodiments, this step may be identical to the steps described in block 325 of FIG. 3 and/or block 405 in FIG. 4.

Returning to decision block 505, if one or more child devices are detected in the provisioning metadata, the method proceeds to block 515.

In block 515, each device identification of each child device of the plurality of child devices is scrambled to a random identification. In some embodiments, the random identification is based on a random number seed of each child device generated at the time of manufacture.

In decision block 520, it is determined whether there is a conflict between the random IDs of two or more child devices of the plurality of child devices. As used herein, a conflict exists when two or more random IDs are identical to one another. In some embodiments, the conflict may be detected when two or more responses from two or more devices each include a complete packet and a checksum failure, as described in detail in method 600 of FIG. 6. If a conflict is detected, the method proceeds to block 525.

In block 525, each random ID of each child device of a subset of child devices having one or more conflicts (i.e. each child device of the two or more child devices having responses with a complete packet and a checksum failure) are re-scrambled iteratively. The method then returns to decision block 520.

Returning to decision block 520, if conflicts are still detected, the method returns to block 320. In this manner, the random IDs may be iteratively re-scrambled until every child device of the one or more child devices has a unique random ID. If no conflicts are detected, the method proceeds to block 530.

In block 530, each child device is assigned a unique ID based on their random ID.

In block 535, provisioning data is sent to the one or more child devices simultaneously. In some embodiments, the provisioning data is sent via the non-arbitrated bus. In some embodiments, the emergency lighting system includes a processor, which may send the provisioning data. In some embodiments, the provisioning data includes a predetermined identification and/or provisioning metadata. In some embodiments, the provisioning metadata includes a provisioned location and/or a presence of one or more sub-child devices (such as in embodiments with sub-sub-networks). In some embodiments, after identifying each device of the one or more child devices, all the predetermined or correct (i.e., non-random) provisioning data, including both provisioned ID and other provisioning metadata, is sent in a burst all at once for all child devices of the one or more child devices. After the full burst is received by all child devices (and not before, since all need to happen simultaneously for this process), the method proceeds to block 540.

In block 540, each child device of the one or more child devices is re-mapped to a predetermined provisioned state based on the provisioning data.

FIG. 6 is yet another example method of individualizing device identifications on a non-arbitrated bus, in accordance with the present technology.

In some embodiments, the method 600 may follow any one or methods 300, 400, and/or 500. In some embodiments, the method 600 is a standalone method, independent of any of methods 300, 400, and/or 500. In some embodiments, the method 600 is carried out with an emergency lighting system (such as emergency lighting systems 100, 200). In some embodiments, the emergency lighting system includes a non-arbitrated bus (such as bus 205) and a plurality of devices (such as plurality of light modules 110A, 110B, 110C, 110D . . . 110F and/or one or more light sources 210A, 210B, 210C, 210D, 210E, GPS 220, processor 225, and/or user interface 215).

In decision block 605, it is determined whether one or more child devices are detected. In some embodiments, this is determined with the provisioning metadata as described above. While only a single “sub-network” (i.e., a master device having one or more child devices) is shown as an example in method 600, it should be understood that any number of sub-networks may exist within the emergency lighting system. In some embodiments, each sub-network is provisioned independently and/or sequentially. In other embodiments, each sub-network is provisioned substantially simultaneously. In this manner, a 2-tiered approach is supported for the primary network then all subnetworks, which is designed to allow unified code to support all possible network cases of all possible subnetworks. In some embodiments, this process may be further implemented for sub-sub networks (i.e., subnetworks of the subnetworks) and so on. If no child devices are detected, the method proceeds to block 610. In some embodiments, each device in the plurality of devices is polled with a master device. In some embodiments, the master device is one device of the plurality of devices that has been provisioned (such as with methods 300, 400, and/or 500) to be a master device. While in some embodiments, the master device may give commands to every device of the plurality of devices, in other embodiments, the master device may give commands to only a subset of devices (such as the one or more child devices as described herein).

In block 610, the device of the plurality of devices is assigned a unique device ID. In some embodiments, this step may be identical to the steps described in block 325 of FIG. 3 and/or block 405 in FIG. 4.

Returning to decision block 605, if one or more child devices are detected in the provisioning metadata, the method proceeds to block 615.

In block 615, each device identification of each child device of the plurality of child devices is scrambled to a random identification. In some embodiments, the random identification is based on a random number seed of each child device generated at the time of manufacture.

In decision block 620, it is determined whether there is a time drift detected. As used herein, the term time drift means (1) receiving a successful response, and (2) receiving a second unexpected response received immediately after the first response occurs. Time drift may cause wait time noise, corruption of the next packet but not the packet in the first response, or both due to the time shift. That is, the second device may be just a little slower at responding than the first device, so it didn't cause a checksum failure, but still results in a duplicate detection. If a time drift is detected, the method proceeds to block 625. In some embodiments, after receiving responses from each device of the plurality of devices (or each child device that the master device sends commands to), the master device may determine a failure of two or more messages. In some embodiments, LIN drivers allow communication with the LIN application layer about specific details of a transmission failure (of two or more responses), including how it failed and at what point of the LIN transmission handshake, rather than just marking it as failed and silently moving on. This allows more intelligent information (such as duplicate senders causing a bus collision) to be extracted from the failure data. it is determined whether the two or more responses are complete and include a checksum failure. In some embodiments, LIN collision detection allows the master device to differentiate between “corrupt” or “incomplete” packets and “collided” packets. To do this, any packet that is received as complete (at least minimum number of bytes in expected response period) but with a checksum failure is marked by the driver layer to the application layer as “possibly duplicate senders”, alongside other information about the state of the driver and details of the failure. The LIN driver layer may remain isolated from the application layer for this handshake, and no knowledge of the message itself is required by the application layer (other than expected length of packet), allowing for easy reuse and portability of the LIN driver supporting this software feature. The application layer should support this callback by the driver layer, but if unpopulated and unsupported by the LIN application there is no negative impact on the LIN driver itself. The advantages of the LIN collision detection are allowing auto-provisioning of “out of the box” LIN devices in a complex and feature rich LIN network, especially ones consisting of near the maximum LIN node count of 16. More advantages include auto detection of misconfigured networks, as well as automated resolution of these misconfigured networks (such as with methods 300, 400, and/or 500). If either a complete package was not received or a checksum failure was not detected, the method proceeds to block 635. In some embodiments, the failure is determined to not be a duplicate sender failure. In some embodiments, the system may be configured to alert a user to another error that may be present. Optionally, a retransmission may be queued. In some embodiments, every device of the plurality of devices may be polled by the master device again. In some embodiments, only the two or more devices that sent the two or more responses determined to be failed transmissions are queued to retransmit. In some embodiments, after each retransmission, the method may return to determine if each response was complete and included a checksum failure. The application layer may then queue a retransmission message any number of times, to determine if the same “possibly duplicate senders” callback is hit each time. In the event that the number of retransmits happen normally then the event is marked as random corruption, however if identical “unique” failure states occur on each subsequent retransmission then more helpful conclusions may be reached. In some embodiments, retransmission is queued a set number of times before proceeding to block 625.

In block 625, each random ID of each child device of a subset of child devices having one or more conflicts (i.e. each child device of the two or more child devices having time drift responses) are re-scrambled iteratively. The method then returns to decision block 620.

Returning to decision block 620, if time drift is still detected, the method returns to block 620. In this manner, the random IDs may be iteratively re-scrambled until every child device of the one or more child devices has a unique random ID. If no time drift detected, the method proceeds to block 630.

In block 630, each child device is assigned a unique ID based on their random ID.

In block 635, provisioning data is sent to the one or more child devices simultaneously. In some embodiments, the provisioning data is sent via the non-arbitrated bus. In some embodiments, the emergency lighting system includes a processor, which may send the provisioning data. In some embodiments, the provisioning data includes a predetermined identification and/or provisioning metadata. In some embodiments, the provisioning metadata includes a provisioned location and/or a presence of one or more sub-child devices (such as in embodiments with sub-sub-networks). In some embodiments, after identifying each device of the one or more child devices, all the predetermined or correct (i.e., non-random) provisioning data, including both provisioned ID and other provisioning metadata, is sent in a burst all at once for all child devices of the one or more child devices. After the full burst is received by all child devices (and not before, since all need to happen simultaneously for this process), the method proceeds to block 640.

In block 640, each child device of the one or more child devices is re-mapped to a predetermined provisioned state based on the provisioning data.

FIG. 7 is an example method 700 of reconfiguring a system having a plurality of devices communicatively coupled to a non-arbitrated bus.

In some embodiments, the method 700 may follow any one or methods 300, 400, 500 and/or 600. In some embodiments, the method 700 is a standalone method, independent of any of methods 300, 400, 500 and/or 600. In some embodiments, the method 700 is carried out with an emergency lighting system (such as emergency lighting systems 100, 200). In some embodiments, the emergency lighting system includes a non-arbitrated bus (such as bus 205) and a plurality of devices (such as plurality of light modules 110A, 110B, 110C, 110D . . . 110F and/or one or more light sources 210A, 210B, 210C, 210D, 210E, GPS 220, processor 225, and/or user interface 215).

In block 705, an absent device is detected. In some embodiments, the absent device may be due to a device being removed or disconnected from the emergency lighting system. In some embodiments, the absent device may be due to a device malfunctioning or otherwise failing. In some embodiments, each device (or a subset of devices) of the plurality of devices is monitored and cached by each other, in a decentralized manner with multiple nodes all caching the state of all other devices on the network. In some embodiments, this data is stored in persistent memory that survives power cycles.

In block 710, it is determined whether the device was moved to a new location. In some embodiments, determining whether a device was moved includes detecting a change in location data but matching a unique attribute of a device. If the device was determined to have been moved, the method proceeds to block 715.

In block 715, the device is reprovisioned in a new location. In this manner, a device may be automatically reprovisioned despite being moved. In some embodiments, each device of the plurality of devices (or a subset of the plurality of devices) may share provision data, and then be cached by other devices on the same network (or across separate networks through routing algorithms). In some embodiments, every device is a “single central controller” so that there is no single point of failure that cannot be “auto reprovisioned” by other devices on the network.

Returning to decision block 710, if the device was not moved to a new location, the method proceeds to block 720.

In block 720, a replacement device is detected. In some embodiments, the replacement device has a same type as the absent device. The same type may be specific (i.e., the absent device is a light module of a first configuration and the replacement device is a light module of a first configuration) or a same general category (i.e., the absent device is a light module having a first configuration and the replacement device is a light module of a second configuration, where both the first configuration and the second configuration fall within a “light module” category).

Optionally, in block 725, an alert is issued to a user. In some embodiments, the alert lets the user know that a replacement device has been detected and gives the user the option to provision the replacement device. In other embodiments, the alert may be informational only, and the system may automatically provision the replacement device.

In block 730, the replacement device is provisioned with the same provisioning data as the absent device. Accordingly, the method 700 allows other devices on a network to detect a 1:1 swap of “like types” of devices and auto provision the new device in an identical way to the old device, using previously cached data received from the old device, without manual user intervention.

It should be understood that all methods 300, 400, 500, 600, and 700 should be interpreted as merely representative. In some embodiments, process blocks of all methods 300, 400, 500, 600, and 700 may be performed simultaneously, sequentially, in a different order, or even omitted, without departing from the scope of this disclosure.

The present application may reference quantities and numbers. Unless specifically stated, such quantities and numbers are not to be considered restrictive, but representative of the possible quantities or numbers associated with the present application. Also, in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A, B, and C,” for example, means (A), (B), (C), (A and B), (A and C), (B and C), or (A, B, and C), including all further possible permutations when greater than three elements are listed.

Embodiments disclosed herein may utilize circuitry in order to implement technologies and methodologies described herein, operatively connect two or more components, generate information, determine operation conditions, control an appliance, device, or method, and/or the like. Circuitry of any type can be used. In an embodiment, circuitry includes, among other things, one or more computing devices such as a processor (e.g., a microprocessor), a central processing unit (CPU), a digital signal processor (DSP), an application-specific integrated circuit (ASIC), a field-programmable gate array (FPGA), or the like, or any combinations thereof, and can include discrete digital or analog circuit elements or electronics, or combinations thereof.

An embodiment includes one or more data stores that, for example, store instructions or data. Non-limiting examples of one or more data stores include volatile memory (e.g., Random Access memory (RAM), Dynamic Random Access memory (DRAM), or the like), non-volatile memory (e.g., Read-Only memory (ROM), Electrically Erasable Programmable Read-Only memory (EEPROM), Compact Disc Read-Only memory (CD-ROM), or the like), persistent memory, or the like. Further non-limiting examples of one or more data stores include Erasable Programmable Read-Only memory (EPROM), flash memory, or the like. The one or more data stores can be connected to, for example, one or more computing devices by one or more instructions, data, or power buses.

In an embodiment, circuitry includes a computer-readable media drive or memory slot configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as any form of flash memory, magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., transmitter, receiver, transceiver, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the embodiments disclosed herein are non-limiting, and the inventors contemplate that other embodiments within the scope of this disclosure may include structures and functionalities from more than one specific embodiment shown in the figures and described in the specification.

In the foregoing description, specific details are set forth to provide a thorough understanding of exemplary embodiments of the present disclosure. It will be apparent to one skilled in the art, however, that the embodiments disclosed herein may be practiced without embodying all the specific details. In some instances, well-known process steps have not been described in detail in order not to unnecessarily obscure various aspects of the present disclosure. Further, it will be appreciated that embodiments of the present disclosure may employ any combination of features described herein.

The present application may include references to directions, such as “vertical,” “horizontal,” “front,” “rear,” “left,” “right,” “top,” and “bottom,” etc. These references, and other similar references in the present application, are intended to assist in helping describe and understand the particular embodiment (such as when the embodiment is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

While illustrative embodiments have been illustrated and described, it will be appreciated that various changes can be made therein without departing from the spirit and scope of the invention.

While illustrative embodiments have been illustrated and described, it will be appreciated that various changes can be made therein without departing from the spirit and scope of the invention.

What is claimed is:

1. A method of individualizing device identifications on a non-arbitrated bus, the method comprising:
communicatively coupling each device of a plurality of devices to the non-arbitrated bus;
scrambling all device identifications to random device identifications based on a random seed of each device of the plurality of devices; and
when one or more conflicts in the random device identifications is detected:
re-scrambling each device of a subset of the plurality of devices, wherein the subset of the plurality of devices comprises each device having the one or more conflicts, and
assigning each device of the plurality of devices a unique device identification.

2. The method of claim 1, further comprising:
after each device of the plurality of devices has a unique device ID, sending provisioning data to each device of the plurality of devices simultaneously; and
re-mapping each device in the plurality of devices to a predetermined provisioned state based on the provisioning data.

3. The method of claim 1, wherein each device of the plurality of devices is selected from a light module, a processor, a global positioning system (GPS), a switch, a horn, a siren, a sensor, a router, a control unit, or a user interface.

4. The method of claim 1, wherein the non-arbitrated bus communicatively couples each device to an emergency vehicle warning light system.

5. The method of claim 4, wherein the emergency vehicle warning light system is coupled to a firetruck, ambulance, car, truck, boat, helicopter, or a specialized utility vehicle selected from mining equipment, construction equipment, road work equipment, a crane, an offroad vehicle, or a military vehicle.

6. The method of claim 1, wherein the provisioning data comprises a predetermined identification.

7. The method of claim 1, wherein the provisioning data comprises provisioning metadata.

8. The method of claim 7, wherein the provisioning metadata comprises a provisioned location, a presence of one or more child devices, or a combination thereof.

9. The method of claim 8, wherein the method further comprises:
when the one or more child devices are detected by a superset device of the plurality of devices:
scrambling child identifications of the one or more child devices,
simultaneously sending child provisioning data to each child device of the one or more child devices simultaneously, and
re-mapping each child device of the one or more child devices to a predetermined provisioned state based on the provisioning data.

10. The method of claim 1, further comprising:
polling the plurality of devices with a master device;
determining a failure in two or more responses provided by the plurality of devices;
when the two or more responses each comprise a complete packet and a checksum failure or an unexpected duplicate response:
categorizing the failure as a duplicate sender failure; and
scrambling each device of the plurality of devices determined to have caused the failure in the two or more responses so that each device of the plurality of devices has a unique identifier.

11. The method of claim 10, wherein the method further comprises:
queuing a retransmission message a predetermined number of times to confirm the duplicate sender failure.

12. The method of claim 10, wherein the method further comprises:
detecting a time drift in the failure; and
in response to the time drift, queuing a retransmission message a predetermined number of times to confirm the duplicate sender failure.

13. The method of claim 10, wherein the method further comprises:
detecting multiple responses to a query; and
in response to the multiple responses, queuing a retransmission message a predetermined number of times to confirm the duplicate sender failure.

14. The method of claim 1, wherein the method further comprises:
caching provisioning data of the plurality of devices.

15. The method of claim 14, wherein the provisioning data of the plurality of devices is cached by one or more devices of the plurality of devices.

16. The method of claim 14, wherein the provisioning data of the plurality of devices is cached on an external network communicatively coupled to the non-arbitrated bus with a routing algorithm.

17. The method of claim 14, wherein the provisioning data of the plurality of devices is stored in a persistent memory.

18. The method of claim 14, the method further comprising:
determining that a device of the plurality of devices has moved to a new location; and
re-provisioning the device at the new location.

19. The method of claim 14, further comprising:
detecting an absent device of the plurality of devices;
detecting a replacement device having a same type as the absent device; and
provisioning the replacement device with provisioning data of the absent device.

20. The method of claim 19, the method further comprising:
issuing an alert that the replacement device has been detected.
